(19) United States
(12) Patent Application Publication
(10) Pub. No.: US 2020/0049428 A1
(43) Pub. Date: Feb. 13, 2020

(54) FLUID CHANNELS HAVING PERFORMANCE ENHANCEMENT FEATURES AND DEVICES INCORPORATING SAME

(71) Applicant: Dana Canada Corporation, Oakville (CA)

(72) Inventors: Andrew Jm Buckrell, London (CA); Michael Jr Bardeleben, Oakville (CA); Doug Vanderwees, Mississauga (CA)

(21) Appl. No.: 16/551,887

(22) Filed: Aug. 27, 2019

Related U.S. Application Data
(62) Division of application No. 14/316,955, filed on Jun. 27, 2014, now abandoned.
(60) Provisional application No. 61/840,159, filed on Jun. 27, 2013.
(60) Provisional application No. 61/864,031, filed on Aug. 9, 2013.

(51) Int. Cl. F28F 1/40; B23P 15/26; F28F 1/12; F28F 13/12; F28D 9/00; F24F 12/00; F24F 3/147; F28D 21/00; F28D 1/03

(52) U.S. Cl. CPC F28F 1/40; B23P 15/26; F28F 1/128; F28F 13/12; F15D 1/004; F24F 12/006; F24F 3/147; F28D 21/0015; F28D 1/0341; F28D 9/0056

(57) ABSTRACT

A fluid channel formed with generally triangular-shaped performance enhancement features is disclosed. The fluid channels may be incorporated into heat exchanger or humidifier devices, the performance enhancement features generally having heat transfer and/or mass transfer performance enhancement applications. The heat transfer or mass transfer enhancement features are formed along the inner surfaces of the fluid flow passages of either the heat exchanger or humidifier plates and generally have sharp leading edges that create vortices in the fluid flowing through the passages. The heat or mass transfer enhancements protrude out of the inner surface of the fluid flow passages while leaving the outer surface of the fluid channel free of perforations. Alternatively, heat or mass transfer enhancements may be formed on separate inserts that are affixed to the inner surface of the fluid flow passages. The heat or mass transfer enhancements can be formed in metal plates or plastic plates using a variety of manufacturing techniques.

### CROSS-REFERENCE TO RELATED APPLICATION

This application is a divisional application of U.S. patent application Ser. No. 14/316,955 filed Jun. 27, 2014 which application claims priority to and the benefit of U.S. Provisional Patent Application No. 61/840,159 filed Jun. 27, 2013 under the title HEAT TRANSFER ENHANCEMENT FOR HEAT EXCHANGER CHANNELS AND METHOD OF MANUFACTURING SAME and U.S. Provisional Patent Application No. 61/864,031 filed Aug. 9, 2013 under the title IMPROVED HEAT EXCHANGER AND/OR HUMIDIFIER CHANNELS. The content of the above-noted applications are hereby expressly incorporated by reference into the detailed description of the present application.

### TECHNICAL FIELD

The invention relates to fluid channels for heat exchangers or humidifiers wherein the fluid channels are formed with performance-enhancing features for improving overall heat transfer, mass transfer or both heat transfer and mass transfer performance of the device.

### BACKGROUND

In heat exchangers, particularly of the type used to heat and/or cool fluids, it is common to use heat transfer surfaces, such as fins, positioned between or adjacent to respective fluid flow passages that make up the heat exchanger core in order to increase or improve heat transfer performance. It is also common to use heat transfer surfaces or heat transfer augmentation devices, such as turbulizers, inside the fluid flow passages of the heat exchanger or to form the fluid flow passages with a pattern of protrusions, such as dimples or ribs, in order to increase heat transfer performance of the heat exchanger.

While positioning heat transfer surfaces or heat transfer augmentation devices, such as fins or turbulizers or protrusions, between adjacent fluid flow passages or within fluid flow passages can serve to increase heat transfer performance, heat transfer surfaces or heat transfer augmentation devices are also known to increase pressure drop through the fluid channel or fluid flow passage in which the heat transfer surface or heat transfer augmentation device is located. Pressure drop through a fluid channel has an adverse effect on heat transfer performance therefore, there is a constant need to balance the advantages associated with incorporating heat transfer enhancement features to increase performance with the potential adverse effects associated with increasing pressure drop through the heat exchanger.

Accordingly, there is a need for improved performance-enhancing features for increasing heat transfer performance that can be incorporated into open fluid channels of heat exchangers that may serve to increase heat transfer performance while offering improved pressure drop characteristics through the fluid channels of the heat exchanger.

When considering humidifiers, there is a similar need to improve overall performance of the device by enhancing the overall mass transfer that occurs across the fluid channels forming the humidifier. It has been found that by incorporating similar performance-enhancing features into the open channels or fluid passageways associated with the humidifier can serve to increase mass transfer performance properties of the device. Accordingly, it has been found that incorporating performance-enhancing features into the open channels or fluid passageways of heat exchangers and/or humidifiers that heat transfer and/or mass transfer or both heat transfer and mass transfer of the devices may be improved.

### SUMMARY OF THE PRESENT DISCLOSURE

In accordance with an example embodiment of the present disclosure, there is provided a fluid channel for transmitting a fluid therethrough, comprising first and second spaced apart walls, the first and second spaced apart walls each defining an inner surface and an outer surface; a flow passage defined between the inner surfaces of the first and second spaced apart walls; a fluid inlet in communication with a first end of said flow passage for delivering said fluid to said flow passage; a fluid outlet in communication with a second end of said flow passage for discharging said fluid from said flow passage; a plurality of performance enhancement features formed in the inner surface of at least one of the first and second spaced apart walls of the tubular member; and wherein the performance enhancement features are in the form of spaced apart protuberances that protrude out of the inner surface of the at least one of the first and second spaced apart walls while the outer surface of the at least one of the first and second spaced apart walls provides a generally continuous contact surface that is free of perforations, each protuberance having a pair of sharp leading edges generally directed towards incoming fluid flow.

In accordance with another aspect of the present disclosure there is provided a heat exchanger, comprising a plurality of tubular members arranged in spaced apart generally parallel relationship to each other, each tubular member forming a fluid channel having first and second spaced apart walls, the first and second walls each defining an inner surface and an outer surface; a plurality of first fluid flow passages defined between the inner surfaces of the first and second spaced apart walls of each of the tubular members; a plurality of second fluid flow passages, each second fluid flow passage defined between adjacent tubular members; a pair of inlet and outlet manifolds in communication with said first set of fluid flow passages for inletting and discharging a fluid through said first fluid flow passages; a plurality of performance enhancement features formed on the inner surface of at least one of the first and second spaced apart walls of each of the tubular members; wherein the performance enhancement features are formed with a pair of sharp leading edges, the performance enhancement features protruding out of the plane of the inner surface of the at least one of the first and second spaced apart walls, the outer surface of the at least one of the first and second spaced apart walls providing a generally continuous contact surface free of perforations.

In accordance with another aspect of the present disclosure, the performance enhancement features are heat transfer enhancements and are formed in separate inserts that are then affixed to the inner surface of the tubular members.

In accordance with another exemplary embodiment of the present disclosure there is provided a method of making a fluid channel for a heat exchanger, comprising the steps of providing a sheet of material having a thickness and defining an inner surface and an outer surface; forming a plurality of heat transfer enhancements in said sheet of material in a pattern over the inner surface of said material, said plurality of heat transfer enhancements having sharp leading edges and projecting out of the inner surface of the sheet of material, the outer surface of the sheet of material remaining generally continuous and free of perforations; cutting said sheet of material to a desired size; forming the cut sheet of material into the shape of an elongated tubular member; and sealing a peripheral edge of said elongated tubular member so as to define a fluid channel for transmitting a fluid therethrough by brazing.

In accordance with another exemplary embodiment of the present disclosure there is provided a humidifier, comprising: a plurality plates arranged in a stack, each of said plates defining a plurality of fluid channels in the form of gas flow passages for either a first gas stream or a second gas stream; a plurality of water permeable membranes, wherein one of said membranes is provided between each pair of adjacent plates in said stack, and is sealed to said pair of adjacent plates; wherein said plates are stacked such that gas flow passages for said first gas stream alternate with gas flow passages for said second gas stream throughout said stack, and such that each of the water permeable membranes separates one of the gas flow passages for the first gas stream from one of the gas flow passages for the second gas stream; and wherein the gas flow passages for at least one of said first gas stream and said second gas stream further comprise performance enhancement features in the form of mass transfer enhancement features that protrude out of the surfaces of the gas flow passages, the mass transfer enhancement features having a pair of sharp leading edges generally directed towards incoming flow for forming vortices within the one of said first and second gas streams.

### BRIEF DESCRIPTION OF THE DRAWINGS

Exemplary embodiments of the present disclosure will now be described, by way of example, with reference to the accompanying drawings, in which:

FIG. 1 is a perspective view of a heat exchanger incorporating heat transfer enhancement channels according to an exemplary embodiment of the present disclosure;

FIG. 2 is a partial perspective view of a portion of the heat exchanger taken along section line 2-2 in FIG. 1;

FIG. 3 is a top plan view of a portion of the outer side of a plate that forms a fluid flow passage in the heat exchanger of FIG. 1;

FIG. 4 is a cross-sectional view of the portion of the plate shown in FIG. 3 taken along section line 4-4;

FIG. 5 is a detail view of the encircled portion 5 shown in FIG. 4;

FIG. 6 is a top plan view of a portion of a plate that forms a fluid flow passage or heat transfer enhancement channel in the heat exchanger of FIG. 1;

FIG. 7 is a schematic, cross-sectional drawing of a portion of a fluid flow passage or heat transfer enhancement channel formed with plates as shown in FIG. 6;

FIG. 8 is a schematic, top plan view of a portion of a plate according to an alternate embodiment of the present disclosure that forms a fluid flow passage or heat transfer enhancement channel in the heat exchanger of FIG. 1,

FIG. 9 is a schematic, cross-sectional drawing of a portion of a fluid flow passage or heat transfer enhancement channel formed by plates as shown in FIG. 8;

FIG. 10 is a schematic top plan view of a portion of a plate according to an alternate embodiment of the present disclosure that forms a fluid flow passage or heat transfer enhancement channel in a heat exchanger;

FIG. 11 is a schematic, cross-sectional drawing of a portion of a fluid flow passage or heat transfer enhancement channel formed by plates as shown in FIG. 10;

FIG. 12 is a schematic top plan view of a portion of a plate according to an alternate embodiment of the present disclosure for forming fluid flow passages or heat transfer enhancement channels in a heat exchanger;

FIG. 13 is a schematic, cross-sectional drawing of a portion of a fluid flow passage or heat transfer enhancement channel formed by plates as shown in FIG. 12;

FIG. 14 is a schematic top plan view of a portion of a plate according to an alternate embodiment of the present disclosure for forming fluid flow passages or heat transfer enhancement channel in a heat exchanger;

FIG. 15 is a schematic, cross-sectional drawing of a portion of a fluid flow passage or heat transfer enhancement channel formed by plates as shown in FIG. 14;

FIG. 16 is a schematic, perspective view of a portion of a plate according to an alternate embodiment of the present disclosure for forming fluid flow passages or heat transfer enhancement channels in a heat exchanger;

FIG. 17 is a schematic, top plan view of a portion of the plate shown in FIG. 16;

FIG. 18 is a schematic, perspective view of a portion of a plate according to an alternate embodiment of the present disclosure for forming fluid flow passages or heat transfer enhancement channels in a heat exchanger;

FIG. 19 is a schematic, top plan view of a portion of the plate shown in FIG. 18;

FIG. 20 is a schematic, enlarged detail cross-sectional view of a portion of a material strip used to form fluid flow passages for a heat exchanger;

FIG. 21 is a schematic, detail cross-sectional view of the material strip of FIG. 20 after having heat transfer enhancements according to the present disclosure formed therein;

FIG. 22 is a schematic cross-sectional detail view of the portion of the material shown in FIG. 21 arranged in stacking relationship with a heat transfer surface;

FIG. 23 is a graphical representation illustrating dimensionless heat transfer performance for various forms of heat exchanger fluid flow passages over a range of dimensionless flow;

FIG. 24 is a graphical representation illustrating friction results associated with various forms of heat exchanger fluid flow passages over a range of flow rates typical of said heat exchangers;

FIG. 25 is a detail view of a cutting tool used for forming heat transfer enhancements and a corresponding formed heat transfer enhancement;

FIG. 26 is a partially exploded, schematic cross-sectional view of a portion of a fluid flow passage or heat transfer enhancement channel according to another exemplary embodiment of the present disclosure where an insert is shown spaced-apart from the wall of the fluid flow passage or heat transfer enhancement channel on which it is mounted;

FIG. 27 is a schematic, top, perspective view of the inside of the fluid flow passage of heat transfer enhancement channel shown in FIG. 26;

FIG. 28 is a schematic, top, perspective view of an exemplary heat transfer enhancement formed in accordance with the present disclosure;

FIG. 29 is a schematic perspective view of a humidifier according another exemplary embodiment of the present disclosure;

FIG. 30 is a top perspective view of a corner or a wet plate for the humidifier of FIG. 29;

FIG. 31 is a top perspective view of a corner of a dry plate for the humidifier of FIG. 29; and

FIG. 32 is an enlarged schematic view of a heat transfer and/or mass transfer enhancement feature that is incorporated into the heat exchanger and/or humidifier channels illustrating the trailing vortices formed in the flow stream.

### DETAILED DESCRIPTION OF EXEMPLARY EMBODIMENTS

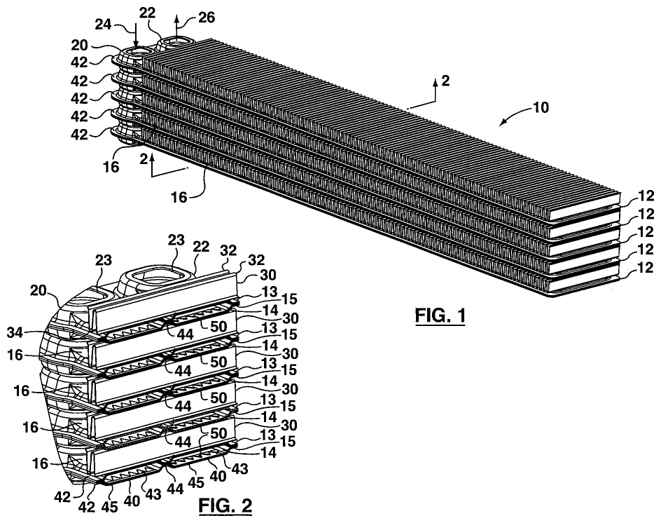

Referring to FIGS. 1 and 2, there is shown an exemplary heat exchanger 10 according to an exemplary embodiment of the present disclosure. Heat exchanger 10 includes a plurality of stacked tubular members 12 that extend in spaced apart, generally parallel relationship to each other. The plurality of stacked tubular members 12, together define a first set of flow passages 14 therethrough for the flow of a first fluid through the heat exchanger 10. A second set of fluid passages 16 is defined between adjacent tubular members 12 for the flow of a second fluid, such as air, through the heat exchanger 10. In the subject embodiment, tubular members 12 are formed by a pair of mating upper and lower plates 13, 15 and, therefore, may also be referred to as plate pairs. It will be understood, however, that tubular members 12 may also be formed as a one-piece tubular member and that the present disclosure is not intended to be limited to tubular members 12 formed as plate pairs.

The tubular members or plate pairs, 12 are each formed with raised embossments or boss portions 20, 22 each having an opening 23 formed therein which serves as an inlet/outlet opening for the flow of the first fluid through the tubular members 12. The boss portions 20, 22 of one tubular member 12 align and mate with the boss portions 20, 22 of the adjacent tubular member 12 in the stack of tubular members 12 to form respective inlet and outlet manifolds 24, 26. In some embodiments, and as shown in FIG. 1, the boss portions 20, 22 are both positioned at one longitudinal end of the tubular members 12 resulting in a generally U-shaped flow path through the tubular member 12 while in other embodiments one boss portion 20, 22 may each be located at respective ends of the tubular members 12 thereby forming a heat exchanger 10 with one manifold 24, 26 located at each of the respective ends of the heat exchanger thereby forming a single-pass heat exchanger. Furthermore, it will be understood that while heat exchanger 10 is shown as a heat exchanger formed of a plurality of stacked tubular members 12 with integral inlet/outlet manifolds 24, 26, heat exchanger 10 may also be formed by tubular members 12 affixed to externally mounted inlet/outlet headers to supply the stack of tubular members 12 with fluid and to receive fluid from them. It will also be understood that while the second set of fluid passages 16 are shown as being open for the flow of a fluid such as freestream air therethrough, the second set of fluid passages 16 could also be fed by a common manifold for the inletting/discharging of a second fluid therethrough. Accordingly, it will be understood that the present disclosure is not intended to be limited to heat exchangers where the second set of fluid passages 16 is open to freestream air, or where the tubular members 12 are formed of mating plate pairs, or where the manifolds 24, 26 are located at one longitudinal end of the heat exchanger 10, as would be understood by persons skilled in the art.

In the exemplary embodiment shown in FIG. 1, heat transfer surfaces 30, or fins, are attached to the outer surfaces of the tubular members 12 and located between adjacent tubular members 12 in the second set of fluid passages 16. Heat transfer surfaces 30 are generally in the form of corrugated members each having generally, parallel spaced apart upper and lower ridges 32, 34 and generally planar fin surfaces 36 extending between the upper and lower ridges 32, 34 as is known in the art. The upper and lower ridges 32, 34 define contact surfaces at their uppermost and lowermost points that generally come into contact with and are intended to seal against or abut in a mating relationship with the outer surfaces of the tubular members 12 when the alternating stack of tubular members 12 and heat transfer surfaces 30 are brazed or otherwise joined together to form heat exchanger 10. While corrugated planar fin surfaces may be used, it will also be understood that other forms of fins, such as louvered fins, or any other suitable heat transfer surface 30 may be used depending upon the particular design and/or application of heat exchanger 10.

In the subject exemplary embodiment, tubular members 12 are formed by mating upper and lower plates 13, 15 that are typically identical to each other in structure with one of the plates 13, 15 being inverted with respect to the other of the plates 13, 15 when positioned in their face-to-face mating relationship. Each plate 13, 15 has a central, generally planar portion 40 surrounded by a peripheral flange 42, the central, generally planar portion 40 defining an inner surface 43 that faces into the fluid flow passage 14 formed by the mating plates 13, 15, and an outer surface 45 that defines one of the second fluid flow passages 16 with the corresponding outer surface 45 of the adjacent tubular member 12. The peripheral flange 42 is located in a different plane from the central, generally planar portion 40 so that when the plates 13, 15 are positioned together in their face-to-face mating relationship, the central, generally planar portions 40 are spaced apart from each other with the peripheral flanges 42 resting against each other in a sealing relationship thereby defining the first set of fluid passages 14 in the space defined therebetween. Accordingly, the inner surfaces 43 of plates 13, 15 define the first fluid passages 14 formed by each set of plate pairs or tubular members 12.

In the illustrated embodiment, boss portions 20, 22 are formed adjacent to each other at one longitudinal end of the tubular members 12. In order to create the U-shaped flow passage within the tubular members 12, an elongated flow divider 44 is formed in the central, generally planar portion of each plate 13, 15 with the flow divider 44 extending from between the two boss portions 20, 22 generally along the mid-line of the plates 13, 15, the flow divider 44 terminating at a point prior to an end edge of the central, generally planar portion 40. The flow divider 44 also extends or projects into the first fluid flow passage 14 formed by the plate pairs, the flow divider 44 on the upper plate 13 in the plate pair mating and coming into contact with the flow divider 44 on the lower plate 15, in the plate pair so as to divide the fluid passage 14 in two thereby creating a U-shaped flow channel. Accordingly, fluid entering the first set of fluid passages 14 flows from the inlet manifold 24 along one side of the tubular member 12 along the length of the plates 13, 15 before making a hair-pin or U-turn at the opposed end of the tubular member 12 before returning to the outlet manifold 26. It will be understood, however, that the subject heat exchanger 10 is not intended to be limited to U-shaped first fluid passages 14 and that various other fluid flow patterns through the heat exchanger 10 (i.e. single pass fluid channels, diagonal pass fluid channels, etc.) are also contemplated within the scope of the present disclosure and may vary depending upon the location of the inlet and outlet manifolds and design of the plates 13, 15 required for a particular application.

Performance enhancement features in the form of heat transfer enhancements 50 are formed on the inner surface 43 of the central, generally planar portion 40 of plates 13, 15 that form tubular members 12. The heat transfer enhancements 50 are in the form of triangular tabs, projections or protuberances that are raised or protrude out of the surface of the central, generally planar portion 40 of the plates 13, 15 from the inner surface 43 thereof and may sometimes be referred to as delta wing tabs or protrusions. As is generally understood in the art, the term “delta wing” refers to a triangular-shaped tab or protrusion wherein the triangular tip or point 52 projects, extends or protrudes out of the surface in which it is formed with the tip or point 52 being oriented upstream from the base 54 of the triangular-shaped heat transfer enhancement 50. The heat transfer enhancements 50 are formed in such a way that a small depression 51 may be formed in the inner surface 43 of the plate or tubular wall around the heat transfer enhancement 50 itself, but the heat transfer enhancements 50 are generally formed so that the outer surfaces 45 of the tubular members 12 provide a continuous surface that is free from perforations or other openings, etc. when the tubular members 12 are formed and/or stacked in their alternating relationship with heat transfer surfaces 30 to form heat exchanger 10. By providing a generally continuous outer surface 45 that is free of perforations or other openings, the tubular members 12 have no leak paths formed therein that would allow fluid flowing within tubular members 12 to exit the tubular member 12. As well, by providing a generally continuous outer surface 45, proper contact is achieved between the adjacent heat transfer surfaces 30 positioned between adjacent tubular members 12.

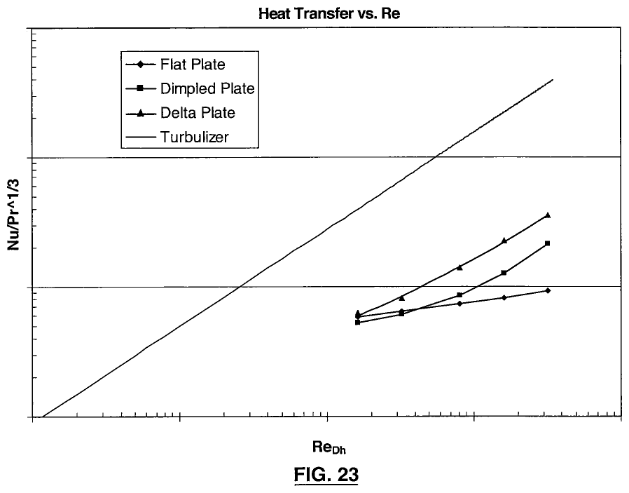

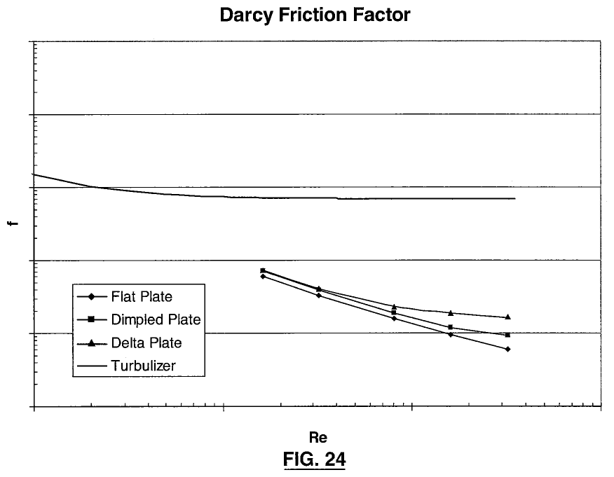

When a fluid (i.e. gas or liquid) flows through the first fluid flow passages 14 formed with the heat transfer enhancements 50, the sharp edges of the triangular-shaped heat transfer enhancements 50 introduce a pair of vortices into the fluid contacting each heat transfer enhancements 50, which vortices are formed along the downstream inner surface 43 of the plates 13, 15 and help to prevent the flow from separating from the inner surface 43 as the flow enters the depression 51 that may be formed around the individual heat transfer enhancements 50. The vortices formed in the fluid flowing through flow passages 14 create a velocity gradient within the fluid which, in turn, creates a temperature gradient when considering the fluid properties moving radially away from the center of each vortice or the vortex core. The abrupt leading edges or the sharp, triangular tip or point 52 of the heat transfer enhancement 50 that project or protrude out of the inner surface of the fluid flow passage 14 results in rather strong vortices being formed along the inner surface 43 of plates 13, 15 that is not typically found with the more commonly employed rounded rib-like protrusions or dimples more commonly formed within heat exchanger fluid flow channels. It has also been found that the triangular-shaped heat transfer enhancements 50 are effective in forming strong vortices within more viscous fluids, such as cold coolants or oils or other known fluids, where the viscous dissipation has previously been found to dominate and quickly destroy any vortice formed within the fluid travelling through the fluid channel 14. Accordingly, heat transfer enhancements 50 formed within the fluid flow passages 14 have been found to help improve heat transfer performance at cold start conditions. It has also been found that tubular members 12 formed with heat transfer enhancements 50 tend to demonstrate improved pressure drop characteristics than that typically found in fluid passages employing turbulizers or devices. FIGS. 23 and 24 illustrate test results related to the heat transfer performance and resulting friction factor of fluid flow passages formed with heat transfer enhancements 50 according to the present disclosure (i.e. “delta plate”) as compared to known fluid flow passages employing turbulizers (i.e. “turbulizer), known dimpled fluid flow passages (i.e. “dimpled plate”) and known fluid flow passages that are free of heat transfer enhancement features (i.e. “flat plate”). As illustrated in the attached graphical representations, heat exchanger channels or fluid flow passages formed with heat transfer enhancements 50 according to the present disclosure (i.e. “delta plate”) offers improved heat transfer performance as compared to the known flat plate or dimpled plate structures, although the heat transfer performance is reduced as compared to fluid flow channels with turbulizers. However, the friction factor resulting from heat transfer enhancements 50 is significantly reduced as compared to fluid flow channels with turbulizers. Heat exchangers incorporating performance enhancement features in the form of heat transfer enhancements 50 may be used for charge-air-cooler (CAC) applications where decreasing pressure drop while improving overall heat transfer performance is desirable.

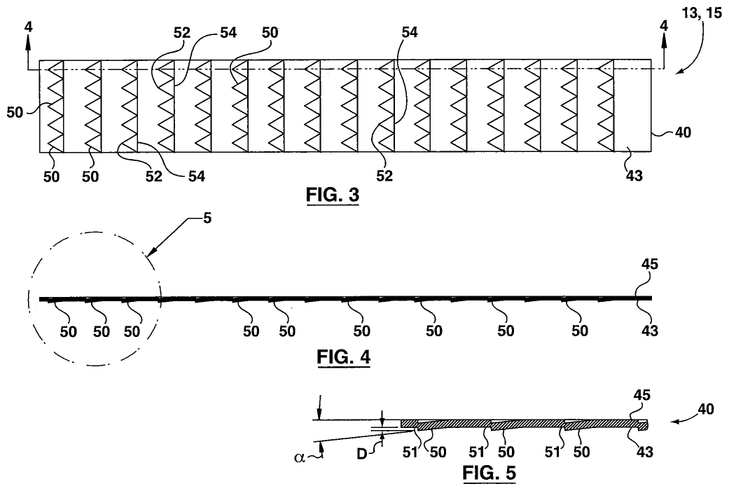

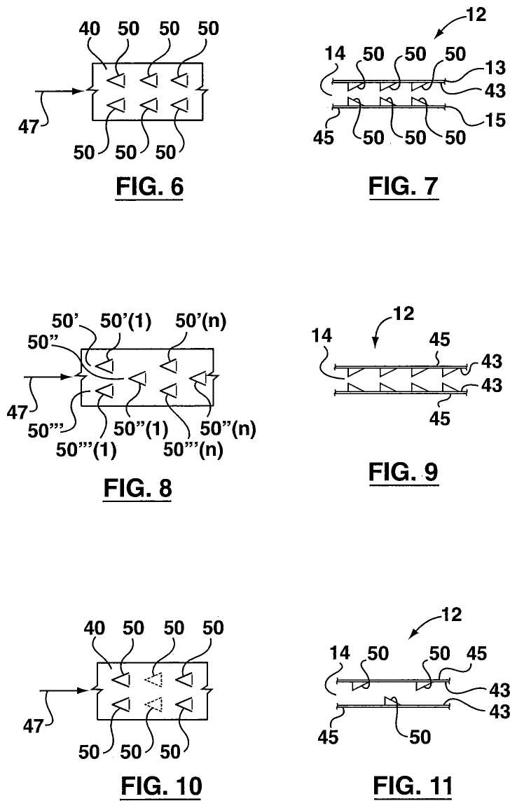

The heat transfer enhancements 50 can be formed on the inner surfaces 43 of the tubular members 12 or plates 13, 15 in various patterns in order to achieve the desired fluid flow properties within the fluid flow passage 14. As shown in FIGS. 3-7, the inner surface 43 can be formed with a series of uniform rows of heat transfer enhancements 50 that extend along the length of the plates 13, 15 or the inner surfaces of the tubular members 12. In the subject example embodiment, each heat transfer enhancement 50 is arranged one behind the other along the length of the plate 13, 15 with generally equal spacing between the subsequent heat transfer enhancement 50. It will be understood that the heat transfer enhancements 50 may also be arranged with unequal spacing between the subsequent heat transfer enhancements 50 within a given row. The rows of heat transfer enhancements 50 are generally arranged parallel to each other and are aligned with the previous row. The rows can be spaced apart from each other by a distance or can be arranged close together such that the downstream corners of the triangular tabs or delta wing tabs in adjacent rows touch effectively forming a saw tooth formation across the width of the plates 13, 15 as shown most clearly in FIG. 3. While five rows of heat transfer enhancements 50 are shown across the width of the plates 13, 15 in FIG. 3, it will be understood that the exact number of rows will depend on the size of the plate 13, 15 and the desired fluid flow properties for a particular application. The heat transfer enhancements 50 project out of the inner surface of the plate 13, 15 by a predetermined distance D, forming a slight depression 51 around or in front of the heat transfer enhancement 50, the heat transfer enhancements 50 forming an angle a with respect to the outer surface 45 of the plate 13, 15 as shown in FIG. 5. The distance D that the heat transfer enhancements 50 are raised out of the inner surface 43 of the plates 13, 15 or the depth of the depression 51 that is formed is generally less than half the depth of the material thickness of the plates 13, 15 themselves and generally less than half of the depth of the fluid flow passage 14 so that the heat transfer enhancements 50 formed on one plate 13, 15 do not come into contact with or interfere with the heat transfer enhancements 50 formed on the other of the two plates 13, 15 when the plates 13, 15 are arranged in their face-to-face mating relationship as shown schematically in FIG. 7, the direction of incoming flow indicated generally by arrow 47 in FIG. 6. Accordingly, the heat transfer enhancements 50 remain spaced apart from each other when the plates 13, 15 are arranged in their face-to-face mating relationship. Depending upon the method of manufacturing the heat transfer enhancements 50, small indentations 64 may be formed in the outer surface 45 of the plates 13, 15 as a result of the formation of the heat transfer enhancements 50, as will be discussed in further detail below. However, these small indentations 64 do not affect the contact between the outer surfaces 45 of the tubular members 12 and the adjacent heat transfer surfaces 16 since the indentations 64 are small relative to the remaining surface area of the tubular members 12 and therefore still provide a generally continuous surface for mating or contacting the adjacent heat transfer surfaces 16. As well, it has been found that any small indentations 64 that may be formed in the outer surface 45 also tend to be filled or sealed with braze material when the components are brazed together to form heat exchanger 10.

Referring now to FIGS. 8 and 9, there is shown another exemplary embodiment of the tubular members 12 with performance enchantment features in the form of heat transfer enhancements 50 according to the present disclosure. In this exemplary embodiment, the triangular heat transfer enhancements 50 are arranged in a staggered pattern as opposed to having all of the triangular heat transfer enhancements 50 arranged in-line with one another. In the staggered arrangement, the triangular heat transfer enhancements 50 in each row are still arranged one behind the other, although they may be spaced farther apart from each other as compared to the embodiment shown in FIG. 6. As shown, the first or uppermost row 50′ of heat transfer enhancements 50 is arranged with the first heat transfer enhancement 50′(1) in a first position and the adjacent or subsequent row of heat transfer enhancements 50″ is arranged parallel to the first row but with the first heat transfer enhancement 50″(1) arranged slightly set back from the first row 50′ in a second position. Accordingly, the heat transfer enhancements 50 in the second row 50″ are arranged in-line with the spaces formed between each of the heat transfer enhancements 50 formed in the first row 50′ across the width of the plate 13, 15 thereby creating the staggered arrangement or pattern. The third or subsequent row of heat transfer enhancements 50′″ is formed so as to mimic the arrangement or positioning of the first row with the first heat transfer enhancement 50′″(1) of the third row 50′″ being arranged in the first position. As with the previous described embodiment, the heat transfer enhancements 50 project or protrude out of the plane of the inner surface of the plates 13, 15 towards the centre of the fluid passage 14 but are sized so as not to interfere or come into contact with each other when the plates 13, 15 are arranged in their face-to-face mating relationship as shown in FIG. 9. As well, while only three rows 50′, 50″, 50′″ of heat transfer enhancements 50 have been shown in the drawings, it will be understood that the present disclosure is not intended to be limited to plates 13, 15 or tubular members 12 being formed with only three rows of heat transfer enhancements 50 arranged in a staggered pattern and that the exact number of rows of heat transfer enhancements 50 may vary depending on the overall size of the plates 13, 15 and/or the particular application of the heat exchanger 10.

Referring now to FIGS. 10 and 11 there is shown another exemplary embodiment of the tubular members 12 with performance enhancement features in the form of heat transfer enhancements 50 according to the present disclosure. In this exemplary embodiment, the position of the heat transfer enhancements 50 on the upper plate 13 (or upper inner surface of the tubular member 12) alternates with the position of the heat transfer enhancements 50 formed on the lower plate 15 (or lower inner surface of the tubular member 12). Due to the alternating placement of the heat transfer enhancements 50 on the upper and lower plates 13, 15 or surfaces, the heat transfer enhancements 50 can be formed so as to project beyond the centerline of the fluid flow passage 14 since the heat transfer enhancements 50 from one of the plates 13, 15 (or inner surfaces 43) extend into the gaps or spaces that are left between successive heat transfer enhancements 50 formed in each, individual row. In the subject exemplary embodiment, all subsequent rows of heat transfer enhancements 50 are identical and arranged parallel and in-line with each other. However, it will be understood that within each row, the heat transfer enhancements 50 can also be spaced apart from each other at varying distances. It will also be understood that subsequent rows can be spaced close together so as to form a saw tooth like configuration across the width of the plates 13, 15 or tubular members 12 or can be spaced farther apart from each other so as maintain a space between adjacent rows. As well, while only two rows of heat transfer enhancements 50 have been shown across the width of the plates 13, 15, it will be understood that this is intended to be illustrative and that the exact number of rows may vary depending on the exact size of the plates 13, 15 or tubular members 12 and the particular application of the heat exchanger 10.

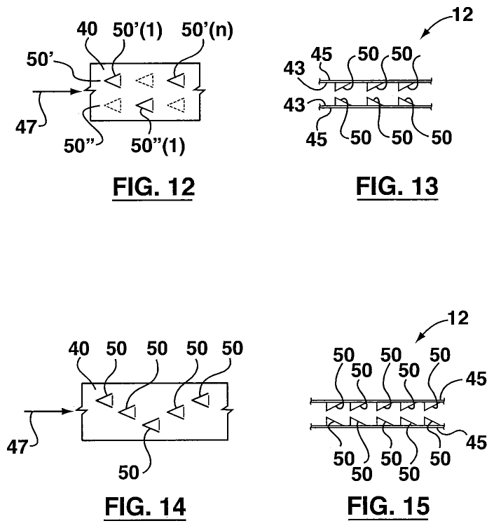

Referring now to FIGS. 12 and 13, there is shown another exemplary embodiment of the tubular members 12 with performance enhancement features in the form of heat transfer enhancements 50 according to the present disclosure wherein the pattern of heat transfer enhancements 50 formed on the upper plate 13 or upper inner surface 43 of the tubular member 12 is the mirror image of the pattern of heat transfer enhancements 50 formed on the lower plate 15 or lower inner surface 43 of the tubular member 12. More specifically, in the illustrated exemplary embodiment the heat transfer enhancements 50 are formed in an alternating or cascading or wave-like pattern along the length of the plates 13, 15 or inner surfaces 43 of the tubular members 12. In the cascading or wave-like pattern, while the heat transfer enhancements 50 in each individual row are essentially arranged in an in-line pattern with one heat transfer enhancement 50 being arranged behind the other, the spacing between each individual heat transfer enhancement 50 is larger or increased as compared to the exemplary embodiment described in connection with FIGS. 6 and 7. Accordingly, when considering the first or upper plate 13 (or upper inner surface 43 of tubular member 12), shown in solid lines in FIG. 12, the first or uppermost row 50.′ of heat transfer enhancements 50 is formed so that the first heat transfer enhancement 50′(1) is formed in a first position proximal to the leading edge of the plate 13, 15 or tubular member 12 with the remaining heat transfer enhancements 50′(n) in the row 50′ being formed at spaced apart intervals behind the first heat transfer enhancement 50′(1) along the length of the surface 43. The second or adjacent row 50″ of heat transfer enhancements 50 is formed so that the first heat transfer enhancement 50″(1) is set back from the leading edge of the plate 13, 15 or tubular member 12 by means of a predetermined distance so that each heat transfer enhancement 50″(n) is formed slightly downstream from the corresponding heat transfer enhancement 50(n) in the first row 50′ with this pattern continuing along the length of the plate 13, 15 or inner surface 43. The second or lower plate 15 (or lower inner surface 43 of tubular member 12) is formed with the opposite pattern of heat transfer enhancements 50 as to what is formed on the first or upper plate 13 as shown in dotted or stippled lines in FIG. 12. Accordingly, the first row 50′ of heat transfer enhancements 50 is formed so that the first heat transfer enhancement 50(1) is set back from the leading edge of the plate 15 (or inner surface 43 of the tubular member 12) while the second or adjacent row 50″ is formed with the first heat transfer enhancement 50(1) being formed at the leading edge with each subsequent heat transfer enhancement 50(n) in the row 50″ being spaced one behind the other along the length of the plate 15 (or inner surface 43). This arrangement once again allows for the heat transfer enhancements 50 to project out of the inner surface 43 of the respective plate 13, 15 (or upper and lower surface of the tubular member 12) so that they extend beyond the centerline of the fluid flow passage 14 since each heat transfer enhancement 50 can extend into the space or gap between successive heat transfer enhancements 50 in the corresponding row formed on the opposite plate 13, 15 (or inner surface 43). A cross-sectional view through fluid flow passage 14 formed by plates 13, 15 or tubular members 12 with heat transfer enhancements 50 as described above is shown in FIG. 13.

FIGS. 14 and 15 illustrate a variation of the exemplary embodiment described above in connection with FIGS. 12 and 13, wherein the plates 13, 15 or tubular members are formed with heat transfer enhancements 50 arranged in a cascading or wave-like pattern as described above, however, in this specific embodiment the pattern formed on the first or upper plate 13 (or upper inner surface 43 of the tubular member 12) is the same as the pattern formed on the second or lower plate 15 (or lower inner surface 43 of the tubular member 12) with the heat transfer enhancements 50 on the second or lower plate 15 being arranged directly beneath the heat transfer enhancements 50 formed on the first or upper plate 13. Accordingly, in this exemplary embodiment the heat transfer enhancements 50 on the respective plates 13, 15 or inner surfaces of the tubular members 12 do not project beyond the centerline of the fluid flow passage 14 so as not to interfere with each other when the tubular members 12 are formed or the plates 13, 15 are arranged in their face-to-face mating relationship.

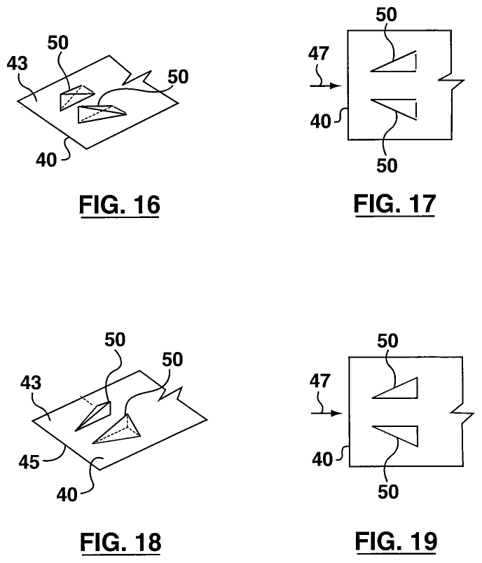

Referring now to FIGS. 16 and 17, there is shown another exemplary embodiment of performance enhancement features generally in the form of heat transfer enhancements 50 according to the present disclosure wherein the heat transfer enhancements 50 are triangular in shape but are not in the form of a symmetric triangular projection or protrusion. More specifically, the edges of the triangular heat transfer enhancements 50 extend at different angles with respect to a centerline extending through the tip or point of the heat transfer enhancement 50. Accordingly, in the subject exemplary embodiment the triangular heat transfer enhancements 50 are not necessarily aligned with the mean flow direction (indicated generally by arrow 47) and can, instead, be facing at any angle to the incident flow while still achieving improved heat transfer performance, or in the case of a humidifier, improved overall mass transfer. It will be understood, of course, that while only two performance enhancement features or heat transfer enhancements 50 have been shown in FIGS. 16 and 17, the non-symmetric heat transfer enhancements 50 could be arranged in any of the patterns described in connection with any of the previously described embodiments. Furthermore, it will be understood that while the subject exemplary embodiment, and the previously described embodiments, have been shown in connection with generally rectangular plates 13, 15 or generally rectangular tubular members 12, non-rectangular plates or non-rectangular tubular members are also contemplated within the scope of the present disclosure. In fact, non-symmetrical triangular heat transfer enhancements 50 of the type shown in FIGS. 16 and 17 are particularly suited to applications where the plates 13, 15 or tubular members 12 are not rectangular and where the flow is not expected to be uni-directional since the symmetric and/or non-symmetrical heat transfer enhancements 50 can be oriented in varying directions in order to help align them with the mean flow path.

Referring now to FIGS. 18 and 19, there is shown another exemplary embodiment of the heat transfer enhancements 50 according to the present disclosure wherein the triangular-shaped performance enhancement features or heat transfer enhancements 50 are oriented with the triangular tip directed away from the incident flow (represented generally by arrow 47) so that the edges of the triangular shaped heat transfer enhancement 50 are incident to the incoming flow. As the edges of the heat transfer enhancement 50 are sharp it has been found that even if the tips are oriented away from or at an angle to the incoming flow, they still create the desired vortices within the fluid flow that leads to the improved heat transfer and pressure drop performance.

Exemplary methods for manufacturing heat exchanger plates 13, 15 and tubular members 12 in accordance with the present disclosure will now be described.

Heat exchanger 10 is formed by first providing a sheet of material or metal strip, preferably comprised of a brazeable material which is preferably selected from the group comprising aluminum, an aluminum alloy, and aluminum or aluminum alloy coated with a brazing filler metal or material. The material or metal strip may then be processed through a series of progressive dies to form the heat transfer enhancements 50 within the metal strip, the additional features of the plates 13, 15, such as the boss portions 20, 22 with inlet/outlet openings 23 and the central generally planar portion 40 surrounded by the peripheral flange 42, also being formed therein. Alternatively, the sheet or material or metal strip can be used to provide a plurality of blanks that serve as blank templates for the formation of plates 13, 15. The blanks can be stamped, or bent, or otherwise suitable formed into plates 13, 14 in order to provide the central, generally planar portion 40 surrounded by peripheral flanges 42. Boss portions 20, 22 with inlet/outlet openings 23 are also formed in the blanks in accordance with principles known in the art. Once the basic plate structures 13, 15 are provided, the plate structures 13, 15 are subjected to a further press and die step in order to form the heat transfer enhancements 50 in the desired pattern/arrangement across the central, generally planar portion 40 of the plates 13, 15.

According to one exemplary method of manufacturing heat exchanger 10, the triangular or delta wing heat transfer enhancements 50 are formed by partially shearing or cutting triangular shaped slits within the central, generally planar portion 40 in the desired pattern over the surface of the plates 13, 15. The third or remaining edge of the triangular shaped heat transfer enhancement 50 remains attached to the central, generally planar portion 40 and serves as a bend axis for slightly lifting the triangular tips of the heat transfer enhancement 50 out of the plane of the inner surface 43 of the central, generally planar portion 40. As a result of the shearing and/or cutting steps, small openings or perforations are created in the central, generally planar portion of the plates 13, 15. However, due to the small size of the heat transfer enhancements 50 (i.e. the sides of the triangular shaped heat transfer enhancement 50 may be on the order of 1-3 mm) and the small distance that the triangular-shaped heat transfer enhancements 50 are raised out of the surface (i.e. less than half the thickness of the material sheet or strip used to form the plates 13, 15), the cuts or perforations formed in the material will be rather small. When the plates 13, 15 are positioned face-to-face in their mating relationship to form tubular members 12 which are then alternatingly stacked together with heat transfer surfaces or fins 30 to form the heat exchanger 10, the entire stacked arrangement is then brazed together in a brazing furnace. Through the brazing process, the braze filler metal or material flows around the triangular slits that form heat transfer enhancements 50 so as to fill in any gaps or openings created by the shearing or cutting process. Accordingly, the tubular members 12 within the formed heat exchanger 10 are intended to be completely sealed during the brazing process and do not have any openings or gaps that would create a leak path that would allow the fluid flowing through tubular members 12 to pass through the outer surface 45 of the tubular member 12.

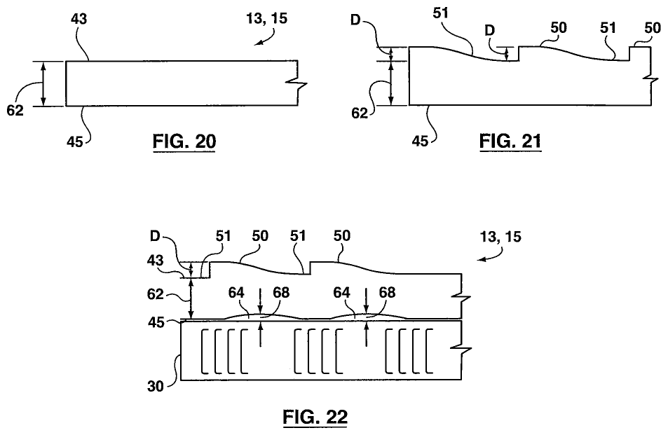

According to another exemplary method of manufacturing heat exchanger 10, the triangular or delta wing heat transfer enhancements 50 are formed by means of a coining process where the material forming the plates 13, 15 instead flows into a female die in order to from the heat transfer enhancements 50 on the inner surface 43 of the plates 13, 15 rather than shearing or cutting the material that forms the plates 13, 15. The coining process for forming the triangular or delta wing heat transfer enhancements 50 will now be described in further detail making reference to FIGS. 20-22.

FIG. 20 shows a cross-sectional view of a portion of a plate 13, 15 or wall of a tubular member 12 that forms heat exchanger 10 that has an initial, generally uniform thickness as represented by arrow 62 in the drawing. During the coining process, the material is held between corresponding male and female dies. As a result, a depression 51 having approximately the same size or volume as the heat transfer enhancement 50 feature is formed around the heat transfer enhancement 50. An indentation 64 may also be formed on the underside or outer surface 45 of the plate 13, 15 as shown in FIG. 22. As the dies are pressed together, the material flows into the female die (not shown) positioned on the upper side or inner surface 43 of the plate 13, 15 or strip material filling the shape formed in the die creating the sharp leading edges of the triangular shaped or delta wing heat transfer enhancement 50 similar to the sharp leading edges formed by shearing/cutting. Because the coining process relies on material flow as opposed to shearing/cutting, no opening or separation is formed in the plate 13, 15 or tubular member 12 that could otherwise form a leak path from the interior of the tubular member 12 to the exterior of the tubular member 12. However, as a result of the coining process, the underside or outer surface of the plates 13, 15 or tubular member 12 may be formed with a series of indentations 64 within the surface corresponding to each of the heat transfer enhancements 50 formed on the inner surfaces 43 of the plates 13, 15 or tubular members 12. Accordingly, when the plates 13, 15 are positioned in their face-to-face mating relationship to form tubular members 12, and the tubular members 12 are then alternatingly, stacked together with heat transfer surfaces or fins 30 to form the heat exchanger 10, small gaps 68 are created at the braze surface between the outer surface 45 of the tubular member 12 and the contact surfaces of the adjacent heat transfer surface 30 as a result of indentations 64 as shown in FIG. 22. However, it will be understood that the height of the gaps 68 formed in the surface 45, indicated generally by arrow 68, is quite small given the rather small overall size of the heat transfer enhancement 50. Therefore, when the entire assembly is brazed together in a brazing furnace, capillary action will draw the braze filler metal or material into the regions of the gaps 64 allowing for a good seal and continuous contact to be formed between the tubular members 12 and the adjacent heat transfer surfaces 30. By ensuring that there is continuous contact between the outer surface 45 of the tubular members 12 and the adjacent heat transfer surfaces 30, the mean conduction length between the two surfaces is reduced which thereby promotes heat transfer. Accordingly, overall heat transfer performance of the heat exchanger 10 is not adversely affected by the fact the outer surfaces 45 of the tubular members 12 may initially be formed with indentations 64.

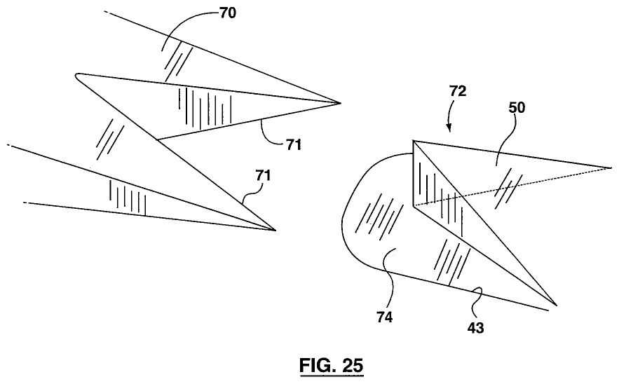

According to another exemplary method of manufacturing heat exchanger 10, the triangular or delta wing heat transfer enhancements 50 are formed by means of a cutting tool that is used in a press and die arrangement or roll forming process and does not distort the underside or outer surface 45 of the plates 13, 15 or material strip used to form tubular members 12. In a typical press and die arrangement, a cutting tool 70, as illustrated in FIG. 25, is pressed or driven down against the inner surface 43 of the material forming the plates 13, 15 or tubular members 12. As a result of the downwards action of the cutting tool 70 and the sharp cutting edges 71 of the cutting tool, a small volume of material 72 is pushed out or up from the inner surface 43 of the material thereby forming the triangular shaped or delta wing heat transfer enhancement 50 with sharp leading edges. A small depression or corresponding groove 74 may be formed on the inner surface 43 of the material as a result of the formation of the heat transfer enhancement 50, as represented by the shaded area in FIG. 25, but this depression or groove does not extend through the thickness of the material leaving the underside or the outer surface 45 of the material untouched. Accordingly, no potential leak path is formed in the material forming the tubular members and the outer surface 45 provides a continuous, uninterrupted or distorted surface for forming a strong and heat transfer promoting seal between the tubular members 12 and the adjacent heat transfer surfaces 30 or fins. While a press and die configuration would primarily be used for forming heat transfer enhancements according to the subject method, it has also been found that for very small scale applications, a basic spade chisel and small mallet can be used to form the heat transfer enhancements 50 of this nature.

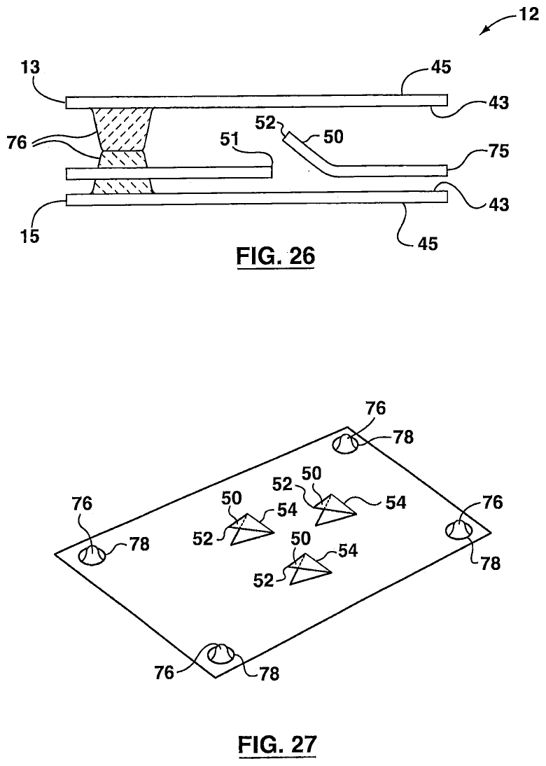

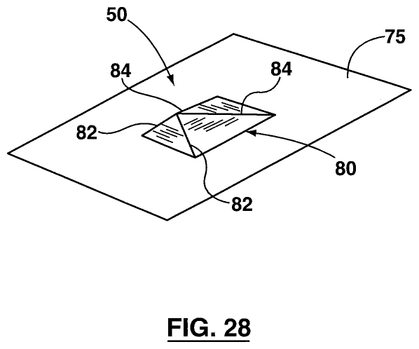

In accordance with yet another exemplary embodiment of the present disclosure, heat exchanger 10 is comprised of tubular members or plate pairs 12 that are provided with inserts 75 mounted to or otherwise affixed to the inner surface 43 of the central, generally planar portions 40 of the spaced-apart walls or plates 13, 15 of the tubular members 12 as shown generally in FIGS. 26 and 27. Inserts 75 are comprised of thin sheets of material that have been lanced or otherwise cut or pierced to form a plurality of heat transfer enhancements 50 over the sheet of material in any of the patterns or arrangements discussed above in connection with FIGS. 3-19. Accordingly, in some embodiments the inserts 75 are provided with a plurality of generally triangular-shaped or delta wing shaped heat transfer enhancements 50 with the tips 52 and sharp leading edges projecting or extending out of the plane of the insert and oriented generally upstream from the attached base 54. When the heat transfer enhancements 50 are formed by lancing, as illustrated in FIG. 28, the heat transfer enhancements 50 are more in the form of raised triangular, pyramid or diamond shaped protrusions 80 with sharp leading edges 82 raised out of the plane of the material forming the insert 75 and oriented generally upstream from downwardly sloping sides 84 of the protrusion 80.

By providing separate inserts 75 that are brazed or otherwise affixed to the inner surfaces 43 of the spaced-apart walls or plates 13, 15 of the tubular members 12, the outer surface 45 of the tubular members 12 remain generally untouched providing smooth continuous contact surface for mating with the corresponding contact surfaces of the adjacent heat transfer surfaces 16. Accordingly, the outer surfaces 45 are free of indentations 64 or slits or other deformities that may be associated with forming the heat transfer enhancements 50 directly in the inner surface of the tubular members 12 themselves and therefore provide a generally smooth, continuous contact surface for mating with or abutting the adjacent fins or heat transfer surfaces 16.

In order to ensure that the inserts 75 are appropriately positioned on the inner surfaces 43 of the plate pairs 13, 15 or tubular members 12, the plates 13, 15 or inner surfaces 43 of the tubular members 12 are formed with at least two locating dimples 76 that project out of the plane of the inner surface 43. Corresponding openings 78 are formed in the inserts 75 so that when the inserts 75 are positioned on the inner surface 43 of the plates 13, 15 or inner walls of the tubular members 12, the locating dimples 76 extending through the corresponding openings 78 thereby holding the inserts 75 in position with respect to the central, generally planar portion 40 of the plates 13, 15 or tubular members 12. The locating dimples 76 may also serve to support the plates 13, 15 or the walls of the tubular members 12 in their spaced-apart parallel relationship. More specifically, when the plates 13, 15 are positioned in their face-to-face relationship, the locating dimples 76 on one of the plates 13, 15 align and abut against the locating dimples 76 formed on the other of the plates 13, 15. While FIG. 27 shows locating dimples 76 being formed generally in the four corners of the plates 13, 15 it will be understood that only a pair of locating dimples 76 may be provided, for instance in diagonally opposed corners of the plates 13, 15. Alternatively, any suitable arrangement of locating dimples 76 may be used to ensure that the inserts 75 are appropriately located on the inner surface 43 of the plates 13, 15 or walls of the tubular members 12 and to provide appropriate support for spacing apart the walls or plates 13, 15 forming the tubular members 12.

In order to form a heat exchanger 10 incorporating inserts 75 as described above in connection with FIGS. 26, 27, heat exchanger plates 13, 15 having a basic structure for forming tubular members can be formed by stamping a sheet of material. A second sheet of material having an appropriate thickness is also provided, the second sheet of material being lanced, cut or pierced in order to form the plurality of heat transfer enhancements 50 in the desired pattern over the surface thereof. The second sheet of material can then be cut into appropriate lengths in order to generally correspond to the central generally planar portions 40 of the heat exchanger plates 13, 15 to form inserts 75. The inserts 75 can then be arranged and brazed or otherwise affixed to the inner surface of the plates 13, 15, the plates 13, 15 being arranged in face-to-face mating relationship to form tubular members 12. The tubular members 12 are then arranged in spaced-apart generally parallel relationship to each other with heat transfer surfaces 16 arranged between adjacent tubular members 12 to form the heat exchanger or heat exchanger core 10. Alternatively, inserts 75 can be positioned within the elongated tubular members 12 adjacent at least one of the inner surfaces 43 to provide fluid flow passages with heat transfer enhancements 50 formed therein.

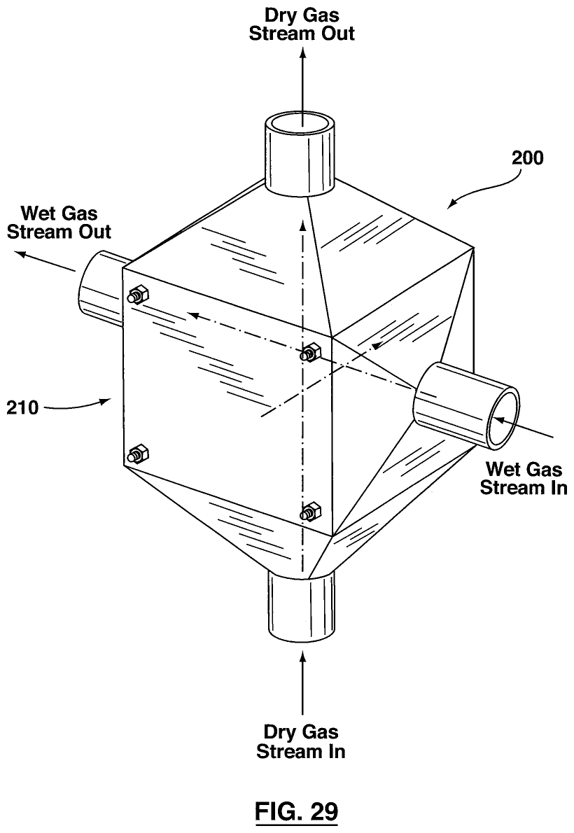

While various exemplary embodiments of heat exchanger plates 13, 15 or tubular members 12 with heat transfer enhancement features 50 have been described along with methods of manufacturing the same, it will be understood that the heat transfer enhancement features 50 may also be incorporated into the plates or flow passages of a variety of different heat exchanger structures, including nested dish-style heat exchangers or other known heat exchanger structures including self-enclosing heat exchanger structures. Accordingly, the heat transfer enhancements 50 may be incorporated in or formed as part of the interior surface of the flow channels of a variety of different heat exchangers. The heat transfer enhancement features 50 described above, however, have also been found to be useful in improving other performance properties of various devices and, in that respect, are not necessarily limited to heat transfer enhancement. More specifically, as mentioned above, it has been found that the generally triangular shaped heat transfer protrusions 50 also serve to improve mass transfer between fluid streams within other devices, such as humidifiers. Accordingly, it will be understood that the above-described heat transfer enhancements 50 may also be referred to as mass transfer enhancement features 150 as will be described in further detail below in connection with FIGS. 29-31. Therefore, the heat transfer enhancements 50 and mass transfer enhancements 150 as disclosed herein both serve as performance enhancement features for fluid channels.

Humidifiers are generally used for transferring water vapour from a first gas stream to a second gas stream. An exemplary embodiment of a humidifier 200 is shown in FIG. 29. As shown, the humidifier 200 is made up of a core 210 comprising a stack of plates and two pairs of manifolds arranged external to the core. The core 210 has a total of six faces with the wet gas stream entering the core 210 through one of its faces and exiting the core through an opposite face. Similarly, the dry gas steam enters the core 210 through one of its faces and exits through an opposite face.

The humidifier core 210 generally comprises a plurality of wet plates 100 and a plurality of dry plates 120 that are stacked in alternating order throughout the stack. For compatibility with moist air, the humidifier plates are generally constructed of polymeric materials and may be manufactured by a molding process, such as compression molding, compression/injection molding, injection molding, sheet molding or thermo-forming, for example. The plates can also be formed by powder metallurgy or rapid prototype printing technology.

In a humidifier, the wet gas stream flows across both the top and bottom surfaces of each wet plate, while the dry gas stream flows across both the top and bottom surfaces of each dry plate. In order to physically separate the wet and dry gas streams from one another and to permit transfer of water vapour from the wet gas stream to the dry gas stream, water permeable membranes are generally sandwiched and sealed between adjacent plates in the stack or humidifier core.

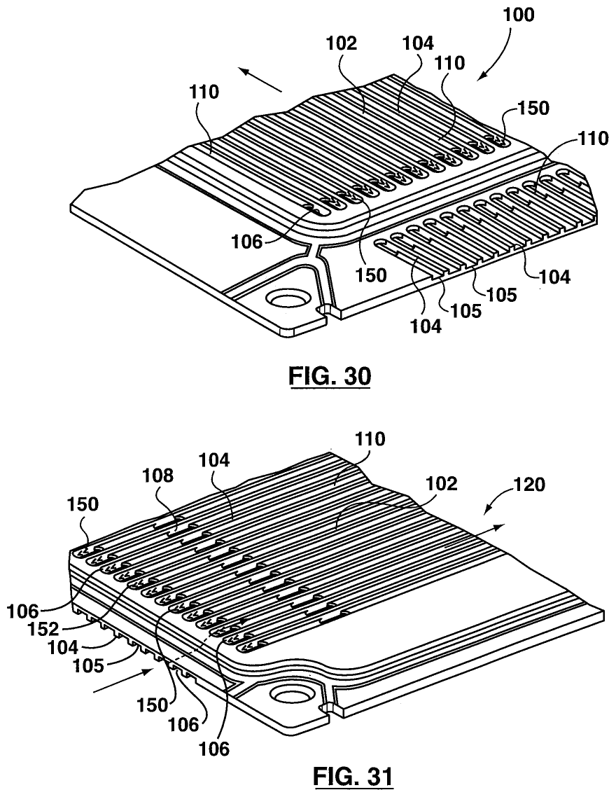

FIG. 30 shows an exemplary embodiment of a humidifier wet plate 100. As shown, the plate 100 comprises a flow field 102 defined by the central portion of the plate 100. The flow field 102 defines the area in which mass transfer or transfer of water vapour takes place between the wet gas stream and the dry gas stream across the water permeable membranes (not shown). Therefore, the area of flow field 102 relative to the total area of plate 100 is preferably maximized with the flow field 102 extending close to the peripheral edges of the plate 100. In the exemplary embodiment shown, the flow field 102 includes a plurality of support structures in the form of support ribs 104 which provide support for the water permeable membrane and other gas diffusion layers that may be stacked or positioned on top of the flow field, the support structures preventing the membranes and/or gas diffusion layers from sagging and constricting or blocking the flow of the wet gas stream across the plate 100. The support ribs 104 extend longitudinally throughout the length of the flow field 102 and are interconnected by web portions 105, the spaces or gaps provided between adjacent support ribs 104 forming channels or flow passages 106 that extend along the length of the plate 100 for the flow of the wet gas stream across the surface of the plate 100. Additional webs 110 may be provided between each of the support ribs 104, the webs 110 being very thin members that extend between the sidewalls 108 of two adjacent support ribs slightly below the upper surface of the plate 100 and do not extend over the full length of the plate 100. The webs 110, therefore create somewhat enclosed flow passages 106 between the support ribs 104, with openings at their respective ends. In some embodiments, the additional webs 110 extending between adjacent support ribs 104 may not necessarily be provided.

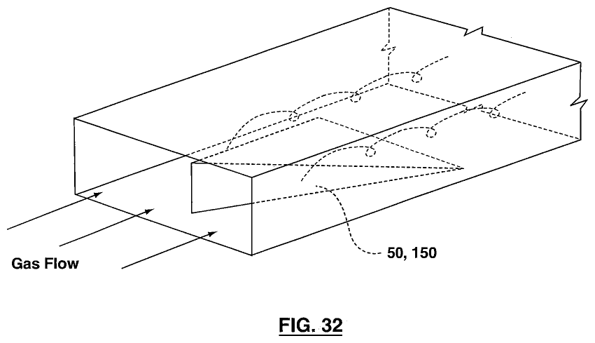

In order to improve mass transfer, i.e. transfer of water vapour from the wet gas stream to the dry gas stream, across the humidifier, the sidewalls 108 and/or web portions 105 and/or webs 110 are formed with vortex generating performance enhancement features or mass transfer enhancement features 150 (shown schematically in FIGS. 30-32) that are similar in structure to the heat transfer enhancement features 50 described above in connection with the above-described heat exchanger embodiments. Accordingly, the vortex generating or mass transfer enhancement features 150 are in the form of generally triangular projections or protuberances that are formed in and are raised out of the surface of the sidewalls 108 and/or interconnecting web portions 105, 110 of the support ribs 104. The mass transfer enhancement features 150 are, therefore, formed on the inner surfaces of the flow channels or passageways 106 and are formed in such a manner so as to leave the sidewalls 108 and webs 105, 110 free of perforations or openings that would otherwise cause leak paths for the gas steam through the plate. The generally triangular projections or protuberances may sometimes be referred to as “delta tabs”. As in the heat exchanger embodiment described above, the triangular tip or point 152 of the mass transfer enhancement feature 150 projects out of the surface of the sidewall 108 or webs 105, 110 so that the tip 152 is oriented upstream from the attached base of the triangular protuberance so that the generally sharp-leading edges of the protuberances introduce counter-rotating vortices into the gas stream. While only one longitudinal row of flow or mass transfer enhancement features 150 is shown in the drawings, it will be understood that this is intended to be illustrative and that the flow mass transfer enhancement features 150 may be arranged or provided in any number of rows or patterns as described above in connection with the heat exchanger embodiments given the overall size of the humidifier plates and the size or surface area provided by the sidewalls 108 of the support ribs 104 and interconnecting webs 105, 110.

FIG. 31 shows an exemplary embodiment of a humidifier dry plate 120. The humidifier dry plates 120 are somewhat similar in structure to the wet plates 100 in that they too define a flow field 102 in the central area of the plate. The flow field is defined by a series of support ribs 104 that extend longitudinally across the length of the plates interconnected by web portions 105. As with the wet plates 100, the support ribs 104 provide support to additional layers, i.e. the water permeable membranes and other gas diffusion layers that may be stacked or positioned on top of the flow field 102. The gaps or spaces provided between each of the support ribs 104 form longitudinally extending flow passages 106 across the flow field for the flow of the dry gas stream across the plates 120. Additional webs 110 that extend between adjacent support ribs 104 may also be provided to provide additional lateral support to the ribs 104 as in the case of the wet plates 100. As with the wet plates 100, the sidewalls 108 of each of the support ribs 104 can also be provided with vortex generating mass transfer enhancement features 150 generally in the form of triangular protuberances that extend or project out of the surface of the sidewalls 108 and/or web portions 105, 110 so that the triangular tips 152 are oriented into the flow of the incoming gas stream as described above in connection with the wet plates 100. Once again, the number of performance enhancement features or protuberances 150 provided and the pattern in which they are arranged may vary depending upon the desired fluid flow properties. In general, it will be understood that the mass transfer enhancement features 150 can be in any of the arrangements described above in connection with the heat exchanger embodiments.

In the humidifier core 210, the wet and dry plates are stacked in alternating relationship, with the appropriate membranes and gas diffusion layers arranged therebetween. The flow field 102 in the wet plates 100 can be arranged at 90 degrees with respect to the orientation of the flow field 102 of the dry plates 120 for a cross-flow arrangement, however, counter-flow arrangements are also contemplated within the scope of the present disclosure where the flow fields 102 of the wet plates 100 extend in the same direction as the flow fields of the dry plates 120. When the wet and dry gas stream flows through the flow fields 102 and the flow passages 106 of the wet and dry plates 100, 120, the leading edges of the mass transfer enhancement features 150 introduce a pair of counter-rotating or swirling vortices into the respective gas streams which has been found to improve overall mass transfer between the two streams thereby increasing the overall performance of the humidifier.

While the mass transfer enhancement features 150 described above have been described as being formed in and projecting out of the surface of the sidewalls 108 and/or webs 105, 110 that form the flow passages 106 in the flow fields 102 of the humidifier plates 100, 120, it will also be understood that the mass transfer enhancements 150 can also be formed in the surface of a separate insert (not shown) that is positioned or otherwise affixed to the sidewalls 108 and/or webs 105, 110 that form the flow passages 106.

Furthermore, while the mass transfer enhancement features 150 have been described as being formed in the flow passages 106 of the flow fields 102 of both the wet plates 100 and the dry plates 120, it will be understood that in some embodiments the mass transfer enhancements 150 may only be formed in the dry plates 120 while in other embodiments they may be formed in only the wet plates 100 depending upon the particular design and/or application associated with the humidifier.

While various exemplary embodiments of the performance enhancement features (e.g. heat transfer enhancement features 50 and mass transfer enhancement features 150) for fluid channels have been described in connection with heat transfer applications associated with various heat exchanger structures as well as in connection with mass transfer applications associated with humidifier structures, it will be understood that certain adaptations and modifications of the described exemplary embodiments can be made as construed within the scope of the present disclosure. As well, while various methods of manufacturing the flow enhancement features in connection with heat exchanger structures have been described and shown in the drawings, it will be understood that these methods can be adapted and modified when the flow enhancement features 50, 150 are incorporated into plastic plates for humidifier applications. Therefore, all of the above discussed exemplary embodiments are considered to be illustrative and not restrictive.

1-24. (canceled)

25. A fluid channel for transmitting a fluid therethrough, comprising:
first and second spaced apart walls, the first and second spaced apart walls each defining an inner surface and an outer surface;
a flow passage defined between the inner surfaces of the first and second spaced apart walls;
a fluid inlet in communication with a first end of said flow passage for delivering said fluid to said flow passage;
a fluid outlet in communication with a second end of said flow passage for discharging said fluid from said flow passage;
a plurality of performance enhancement features formed in the inner surface of at least one of the first and second spaced apart walls of the tubular member; and
wherein the performance enhancement features are in the form of spaced apart protuberances that protrude out of the inner surface of the at least one of the first and second spaced apart walls while the outer surface of the at least one of the first and second spaced apart walls provides a generally continuous contact surface that is free of perforations, each protuberance having a pair of sharp leading edges generally directed towards incoming fluid flow.

26. The fluid channel as claimed in claim 25, wherein the fluid channel is incorporated into one of the following alternative devices: a heat exchanger or a humidifier; and
wherein the performance enhancement features serve as heat transfer enhancement features when incorporated in a heat exchanger device, and serve as mass transfer enhancement features when incorporated in a humidifier device.

27. The fluid channel as claimed in claim 25, wherein the performance enhancement features are in the form of triangular-shaped protuberances having a tip and a base, the tip being oriented generally upstream from the base.

28. The fluid channel as claimed in claim 25, wherein the performance enhancement features are formed on the inner surface of both the first and second spaced apart walls.

29. The fluid channel as claimed in claim 25, wherein the first and second spaced apart walls each have a thickness, the performance enhancement features projecting out of the inner surface of the at least one of the first and second spaced apart walls by a distance less than half the thickness of the wall.

30. A heat exchanger, comprising:
a plurality of tubular members arranged in spaced apart generally parallel relationship to each other, each tubular member forming a fluid channel having first and second spaced apart walls, the first and second walls each defining an inner surface and an outer surface;
a plurality of first fluid flow passages defined between the inner surfaces of the first and second spaced apart walls of each of the tubular members;
a plurality of second fluid flow passages, each second fluid flow passage defined between adjacent tubular members;
a pair of inlet and outlet manifolds in communication with said first set of fluid flow passages for inletting and discharging a fluid through said first fluid flow passages;
a plurality of performance enhancement features formed on the inner surface of at least one of the first and second spaced apart walls of each of the tubular members;
wherein the performance enhancement features are formed with a pair of sharp leading edges, the performance enhancement features protruding out of the plane of the inner surface of the at least one of the first and second spaced apart walls, the outer surface of the at least one of the first and second spaced apart walls providing a generally continuous contact surface free of perforations; and
wherein:
the performance enhancement features are heat transfer enhancements, the heat transfer enhancements being in the form of triangular-shaped protuberances having a tip and a base, the tip being oriented generally upstream from the base;
the heat transfer enhancements are formed in a plurality of rows, the rows extending along the length of the inner surface of the at least one of the first and second walls;
the adjacent rows of heat transfer enhancements are spaced apart from each other along the width of the tubular member; and
the adjacent rows of heat transfer enhancements are arranged proximal to each other forming a saw-tooth arrangement across the width of the tubular member.

31. A heat exchanger, comprising:
a plurality of tubular members arranged in spaced apart generally parallel relationship to each other, each tubular member forming a fluid channel having first and second spaced apart walls, the first and second walls each defining an inner surface and an outer surface;
a plurality of first fluid flow passages defined between the inner surfaces of the first and second spaced apart walls of each of the tubular members;
a plurality of second fluid flow passages, each second fluid flow passage defined between adjacent tubular members;
a pair of inlet and outlet manifolds in communication with said first set of fluid flow passages for inletting and discharging a fluid through said first fluid flow passages;
a plurality of performance enhancement features formed on the inner surface of at least one of the first and second spaced apart walls of each of the tubular members;
wherein the performance enhancement features are formed with a pair of sharp leading edges, the performance enhancement features protruding out of the plane of the inner surface of the at least one of the first and second spaced apart walls, the outer surface of the at least one of the first and second spaced apart walls providing a generally continuous contact surface free of perforations; and
wherein:
the performance enhancement features are heat transfer enhancements, the heat transfer enhancements being in the form of triangular-shaped protuberances having a tip and a base, the tip being oriented generally upstream from the base;
the heat transfer enhancements are formed in a plurality of rows, the rows extending along the length of the inner surface of the at least one of the first and second walls;
the adjacent rows of heat transfer enhancements are spaced apart from each other along the width of the tubular member; and
the adjacent rows of heat transfer enhancements are arranged in one of the following alternative patterns: staggered with respect to one another, or cascading with respect to one another.

32. A method of making a fluid channel for a heat exchanger, comprising the steps of:
providing a sheet of material having a thickness and defining an inner surface and an outer surface;
forming a plurality of heat transfer enhancements in said sheet of material in a pattern over the inner surface of said material, said plurality of heat transfer enhancements having sharp leading edges and projecting out of the inner surface of the sheet of material, the outer surface of the sheet of material remaining generally continuous and free of perforations;
cutting said sheet of material to a desired size;
forming the cut sheet of material into the shape of an elongated tubular member; and
sealing a peripheral edge of said elongated tubular member so as to define a fluid channel for transmitting a fluid therethrough by brazing.

33. The method as claimed in claim 32, wherein said heat transfer enhancements are formed in said sheet of material by coining using a press and die arrangement.

34. The method as claimed in claim 33, further comprising the steps of:
providing a cutting tool in the form of a female die having the negative form of the heat transfer enhancement formed therein, the female die therefore having a generally v-shaped slot providing a pair of cutting surfaces;
pressing the cutting tool downwardly against the inner surface of the sheet of material to form said heat transfer enhancements on the inner surface of the material, the cutting tool leaving the outer surface of the material free of perforations.

35. A humidifier, comprising:
a plurality plates arranged in a stack, each of said plates defining a plurality of fluid channels in the form of gas flow passages for either a first gas stream or a second gas stream;
a plurality of water permeable membranes, wherein one of said membranes is provided between each pair of adjacent plates in said stack, and is sealed to said pair of adjacent plates;
wherein said plates are stacked such that gas flow passages for said first gas stream alternate with gas flow passages for said second gas stream throughout said stack, and such that each of the water permeable membranes separates one of the gas flow passages for the first gas stream from one of the gas flow passages for the second gas stream; and
wherein the gas flow passages for at least one of said first gas stream and said second gas stream further comprise performance enhancement features in the form of mass transfer enhancement features that protrude out of the surfaces of the gas flow passages, the mass transfer enhancement features having a pair of sharp leading edges generally directed towards incoming flow for forming vortices within the one of said first and second gas streams.

36. The humidifier as claimed in claim 35, wherein the mass transfer enhancement features are triangular-shaped having a tip and a base, the tip being oriented generally upstream from the based and directed towards the incoming gas flow.

37. The humidifier as claimed in claim 36, wherein each of said plates comprises:
(i) a flow field defined in a central portion of the plate, the flow field having an open top along the top of the plate and an open bottom along the bottom of the plate; and
(ii) a plurality of support structures located within the flow field and extending between the top and bottom of the plate, the sidewall of one support structure being spaced apart from the sidewall of the adjacent support structure so as to define the flow passages therebetween, the flow passages forming said gas flow passages for either said first gas stream or said second gas stream;
the humidifier further comprising a pair of manifolds for said first gas stream, and a pair of manifolds for said second gas stream, wherein a first pair of said manifolds is in flow communication with a first plurality of said plates defining said gas flow passages for said first gas stream, and wherein a second pair of said manifolds is in flow communication with a second plurality of said plates defining said gas flow passages for said second gas stream, said humidifier for transferring water vapour from said first gas stream to a second gas stream.

38. The humidifier as claimed in claim 37, wherein the plurality of support structures each comprise a pair of sidewalls, the sidewalls of one support structure being interconnected to the adjacent support structure by web portions, the flow passages being defined by said sidewalls and said web portions; and wherein the mass transfer enhancement features are formed on said sidewalls and/or said web portions.

39. The humidifier as claimed in claim 38, further comprising inserts that are positioned on or affixed to the surfaces of said flow passages, the mass transfer enhancement features being formed in said inserts.
